(19) United States
(12) Patent Application Publication
(10) Pub. No.: US 2013/0110370 A1
(43) Pub. Date: May 2, 2013

(54) BRAKE CONTROL DEVICE

(71) Applicant: RYO INOMATA, SUSONO-SHI (JP)

(72) Inventor: RYO INOMATA, SUSONO-SHI (JP)

(73) Assignee: TOYOTA JIDOSHA KABUSHIKI KAISHA, TOYOTA-SHI (JP)

(21) Appl. No.: 13/480,594

(22) Filed: May 25, 2012

Related U.S. Application Data
(63) Continuation of application No. PCT/JP11/06158, filed on Nov. 2, 2011.

(51) Int. Cl. B60T 7/12

(52) U.S. Cl. 701/70

(57) ABSTRACT

Provided is a brake control device that corrects a braking force within a rising period thereof so as to allow an automatic brake device to exert an appropriate braking force regardless of a state of a brake pad, etc. The brake control device is for supporting avoidance of a collision of a vehicle with an obstacle by using an automatic brake control, and includes: a deceleration detector that detects a deceleration of the vehicle; and a controller that controls a braking force of the automatic brake device, based on a change, within a predetermined period, in a degree of deviation between the detected deceleration and a demanded deceleration corresponding to the detected deceleration. The predetermined period is a period included in a rising braking force period starting from when an operation instruction is given to the automatic brake device and ending when the demanded deceleration reaches a predetermined target deceleration.

### TECHNICAL FIELD

The present invention relates to a brake control device, and in more detail, relates to a brake control device that corrects a braking force within a period of rising of the braking force so as to allow an automatic brake device to exert an appropriate braking force regardless of a state of a brake pad and the like.

### BACKGROUND ART

Hitherto, developed as one safety device mounted on a vehicle is a collision-avoidance braking device that recognizes an obstacle in the environs of the vehicle, and supports an operation of a driver such that the travelling vehicle can avoid and not collide with the obstacle.

For example, Patent Literature 1 discloses a true deceleration calculation section for calculating a true deceleration of a vehicle, a target deceleration calculation section for calculating a target deceleration, and a deceleration control device for controlling a brake fluid pressure such that the true deceleration calculated by the true deceleration calculation section becomes equal to the target deceleration calculated by the target deceleration calculation section. More specifically, the true deceleration and the target deceleration are compared with each other, and when the true deceleration is smaller than the target deceleration, a braking force is increased; and when the true deceleration is larger than the target deceleration, the braking force is decreased. With this deceleration control device, the possibility of avoiding a collision can be increased since the braking force is controlled such that the true deceleration becomes equal to the target deceleration.

However, the deceleration control device disclosed in Patent Literature 1 does not take into consideration a period in which the brake begins to become effective (i.e., a rising braking force period). The rising braking force period is a period in which the braking force gradually increases. An increase rate of the braking force in this period differs depending on the degree of wear on a brake pad, steering operation by a driver, weight of the vehicle including passengers, etc. Depending on the degree of wear on the brake pad, etc., a deviation occurs between a predetermined increase rate of the braking force and an increase rate of the actual braking force. The difference in the braking force due to this deviation becomes larger as time elapses in the rising braking force period. It is preferable to correct the braking force within the rising braking force period such that the influence of such deviation is not carried over beyond the rising braking force period.

### CITATION LIST

### Patent Literature

[PTL 1] Japanese Laid-Open Patent Publication No. H8-58543

### SUMMARY OF THE INVENTION

### Problems to be Solved by the Invention

The present invention has been made in view of such actual circumstances, and an objective of the present invention is to provide a brake control device that corrects a braking force within a period of rising of the braking force so as to allow an automatic brake device to exert an appropriate braking force regardless of a state of a brake pad and the like.

### Solution to the Problems

In order to solve the above described problem, the present invention employs the following configuration. That is,

a first aspect of the present invention is

a brake control device for supporting avoidance of a collision of one's own vehicle with an obstacle by using an automatic brake device, the brake control device comprising:

a deceleration detector configured to detect a deceleration of the own-vehicle;

a target deceleration calculating section configured to determine a risk of collision between the own-vehicle and the obstacle, and calculate a target deceleration based on the determined risk; and

a controller configured to set a demanded deceleration that gradually increases as time elapses in a braking force rising period so as to reach the target deceleration, and configured to control a braking force of the automatic brake device, based on a change, within a predetermined period, in a degree of deviation between the detected deceleration and the demanded deceleration at a time point when said deceleration has been detected, wherein

the predetermined period is included in the rising braking force period starting from a time point when an operation instruction is given to the automatic brake device and ending at a time point when the demanded deceleration reaches the target deceleration.

With the first aspect, the braking force is controlled based on the change of the degree of deviation between the detected deceleration and the demanded deceleration, within the predetermined period included in the rising braking force period. With this, it becomes possible to control the braking force part way through the rising braking force period. Therefore, the control of the braking force can be conducted from an early stage, and thereby the automatic brake device can exert an appropriate braking force regardless of a state of a brake pad and the like.

In a second aspect based on the first aspect,

a control of the braking force is initiated at an end time of a predetermined period or at around the end time.

With the second aspect, the control of the braking force can be conducted from an early stage.

In a third aspect based on the first aspect,

in accordance with a change in the degree of deviation, the controller increases or decreases a ratio of change of the demanded deceleration until the demanded deceleration reaches the target deceleration.

With the third aspect, the change ratio of the demanded deceleration prior to reaching the target deceleration can be adjusted in accordance with the effectiveness of the automatic brake device.

In a fourth aspect based on the first aspect,

the controller increases or decreases the target deceleration in accordance with a change in the degree of deviation.

With the fourth aspect, the target deceleration can be increased or decreased in accordance with the effectiveness of the automatic brake device.

In a fifth aspect based on the first aspect,

a start time of the predetermined period is a time point that is reached when a time interval of a delay of a response by the automatic brake device to the operation instruction has elapsed after a time point when the operation instruction has been given.

With the fifth aspect, since the start time of the predetermined time interval is set as a time point that is reached when a time interval of a delay of a response by the automatic brake device has elapsed, the change of the degree of deviation can be appropriately calculated and thereby the braking force can be appropriately controlled.

In a sixth aspect based on the first aspect,

an end time of the predetermined period is a final time point at which a collision with the obstacle is avoidable through steering by a driver.

With the sixth aspect, by setting the end time of the predetermined time interval to the final time point (i.e., a steer-avoidance limit time point) at which a collision with the obstacle can be avoided through steering by the driver, the control of the braking force can be conducted after the steer-avoidance limit time point based on the change in the degree of deviation before the steer-avoidance limit time point.

In a seventh aspect based on the first aspect,

a change in the degree of deviation is a ratio of a difference between the demanded deceleration and the detected deceleration, with regard to the demanded deceleration.

With the seventh aspect, the braking force can be appropriately controlled based on the change in the degree of deviation.

In an eighth aspect based on the first aspect,

a change in the degree of deviation is obtained by integrating a difference between the target deceleration and the detected deceleration over time.

With the eighth aspect, the braking force can be appropriately controlled based on a change in the degree of deviation.

A ninth aspect of the present inventions is

a brake control device for supporting avoidance of a collision of one's own vehicle with an obstacle by using an automatic brake device, the brake control device comprising:

a brake fluid pressure detector configured to detect a brake fluid pressure of the automatic brake device;

a target brake fluid pressure calculating section configured to determine a risk of collision between the own-vehicle and the obstacle, and calculate a target brake fluid pressure based on the determined risk; and

a controller configured to set a demanded brake fluid pressure that gradually increases as time elapses in a braking force rising period so as to reach the target brake fluid pressure, and configured to control a braking force of the automatic brake device, based on a change, within a predetermined period, in a degree of deviation between the detected brake fluid pressure and the demanded brake fluid pressure at a time point when said brake fluid pressure has been detected, wherein

the predetermined period is included in the rising braking force period starting from a time point when an operation instruction is given to the automatic brake device and ending at a time point when the demanded brake fluid pressure reaches the target brake fluid pressure.

With the ninth aspect, the braking force is controlled based on the change of the degree of deviation between the detected brake fluid pressure and the demanded brake fluid pressure, within the predetermined period included in the rising braking force period. With this, it becomes possible to control the braking force part way through the rising braking force period. Therefore, the control of the braking force can be conducted from an early stage, and thereby the automatic brake device can exert an appropriate braking force regardless of a state of a brake pad and the like.

### Advantageous Effects of the Invention

With the present invention, the braking force is corrected within the period of rising of the braking force, and thereby the automatic brake device can exert an appropriate braking force regardless of the state of the brake pad and the like.

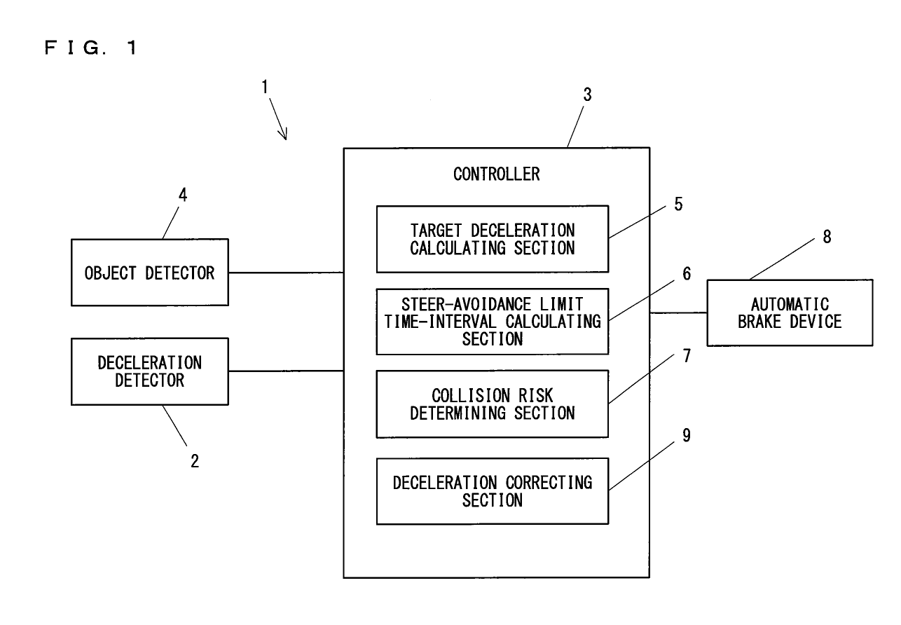

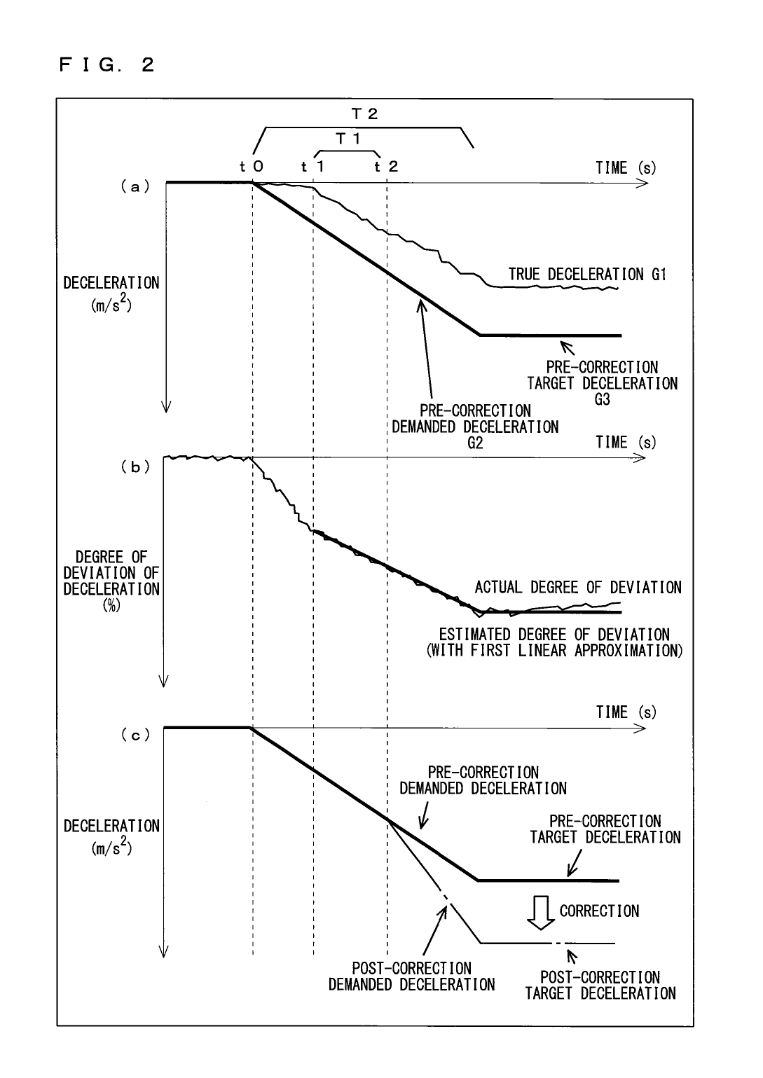

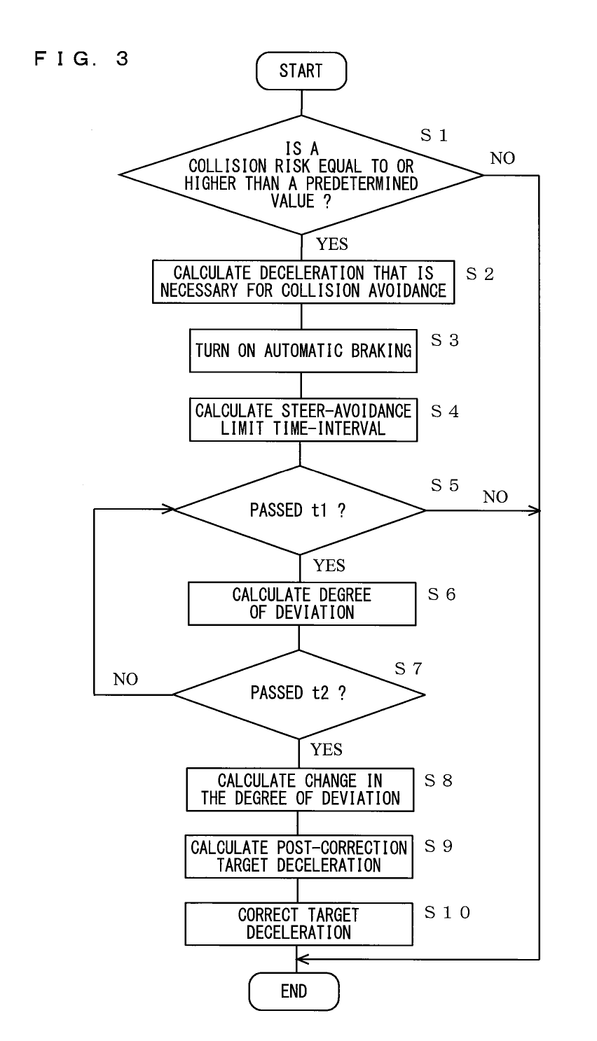

### BRIEF DESCRIPTION OF THE DRAWINGS

[FIG 1] FIG. 1 is a block diagram showing a configuration of a brake control device according to a first embodiment.

[FIG 2] In FIG. 2, (a) shows a relationship between a pre-correction demanded deceleration and a true deceleration, (b) shows a relationship between an estimated degree of deviation and an actual degree of deviation, and (c) shows a relationship between the pre-correction demanded deceleration and a post-correction demanded deceleration.

[FIG 3] FIG. 3 is a flowchart showing an operation of the brake control device according to the first embodiment.

### DESCRIPTION OF EMBODIMENTS

### First Embodiment

A first embodiment of the present invention will be described with reference to the drawings.

FIG. 1 is a block diagram showing a configuration of a brake control device according to the first embodiment. In FIG. 2, (a) shows a relationship between a pre-correction demanded deceleration and a true deceleration, (b) shows a relationship between an estimated degree of deviation and an actual degree of deviation, and (c) shows a relationship between the pre-correction demanded deceleration and a post-correction demanded deceleration.

A brake control device 1 according to the first embodiment is a brake control device for supporting avoidance of a collision of one's own vehicle with an obstacle by using an automatic brake control.

As shown in FIG. 1, the brake control device 1 includes an object detector 4, a deceleration detector 2, and a controller 3.

The object detector 4 detects an obstacle (e.g., another vehicle) existing in the environs of the own-vehicle. The object detector 4 can be formed from, for example, a radar device, a camera device, or the like. The object detector 4 can calculate a relative velocity, a relative distance, etc., between the own-vehicle and the obstacle existing in the environs of the own-vehicle.

The controller 3 controls a braking force of an automatic brake device 8, based on a change within a predetermined period T1 (cf. FIG. 2) in a degree of deviation between a detected deceleration G1 and a demanded deceleration G2 corresponding to the detected deceleration G1. The predetermined period T1 is a predetermined period included in a rising braking force period T2 (cf. FIG. 2).

A start time t1 of the predetermined period T1 is, for example, a time point that is reached when a time interval of a delay of a response by the automatic brake device 8 to the operation instruction has elapsed after a time point t0 when the operation instruction has been given to the automatic brake device 8.

A end time t2 of the predetermined period T1 is, for example, a final time point (collision-avoidance limit time point) at which a collision with the obstacle is avoidable through steering by a driver.

The rising braking force period T2 is a period starting from the time point t0 when the operation instruction has been given to the automatic brake device 8 and ending at a time point when the demanded deceleration G2 reaches a predetermined target deceleration G3 (cf. FIG. 2 (a)).

The demanded deceleration G2 (cf. FIG. 2 (a)) is a value that is set in advance. The demanded deceleration G2 is set within a range that would not influence the steering by the driver. The demanded deceleration G2 is set in advance so as to gradually increase as time elapses in the rising braking force period T2. Thus, a slope of the demanded deceleration G2 represents a preferable value for a rising speed of the braking force.

The target deceleration G3 (cf. FIG. 2 (a)) is a target value of the deceleration. The demanded deceleration G2 is set so as to gradually increase as time elapses, and to stop increasing when it reaches a certain target value. This target value is the target deceleration G3. Therefore, when the demanded deceleration G2 gradually increase as time elapses and reaches the target deceleration G3, the demanded deceleration G2 becomes a certain deceleration. The target deceleration G3 is calculated by the controller 3.

The deceleration detector 2 detects a deceleration of the vehicle. That is, the deceleration detector 2 detects the actual deceleration (hereinafter, referred to as a true deceleration). It should be noted that the deceleration detector 2 can also detect an acceleration. Thus, when a deceleration with a negative value is detected, it means that an acceleration with a positive value is detected. Although the true deceleration ideally increases identical to the demanded deceleration throughout the whole rising braking force period T2, it is often not the case in reality. This is because, the actual braking force does not match a braking force predetermined with regard to a brake fluid pressure, due to wear on the brake pad of the automatic brake device 8, steering operation by the driver, degree of tilt of the own-vehicle, etc.

The change in the degree of deviation is, for example, a time change rate of a ratio of a difference between the demanded deceleration G2 and the detected deceleration G1, with regard to the demanded deceleration G2. Thus, the change in the degree of deviation can be represented as a time change rate of (G1−G2)/G2. This time change rate can be obtained by, for example, sampling (G1−G2)/G2 in the predetermined period T1 for multiple times at a cycle shorter than the predetermined period T1, and obtaining the time change rate of the sampled (G1−G2)/G2 using straight line approximation (by least-square method etc.) (cf. FIG. 2 (b)).

Furthermore, the change in the degree of deviation may be obtained by, for example, integrating a difference between the demanded deceleration G2 and the detected deceleration G1 over time (e.g., the period T1).

An operation of the controller 3 will be described in more detail.

The controller 3 includes collision risk determining section 7 (cf. FIG. 1), target deceleration calculating section 5, steer-avoidance limit time-interval calculating section 6, and deceleration correcting section 9. The controller 3 initiates the control of the braking force at an end time t2 of the predetermined period T1 or around the end time t2 (cf. FIG. 2 (c)).

The collision risk determining section 7 determines a risk of collision between the own-vehicle and the obstacle based on a relative distance and a relative velocity between the own-vehicle and the obstacle.

The target deceleration calculating section 5 calculates the target deceleration G3 based on the risk determined by the collision risk determining section 7.

The steer-avoidance limit time-interval calculating section 6 calculates a steer-avoidance limit time-interval based on the relative distance and relative velocity between the own-vehicle and the obstacle, a lateral acceleration of the own-vehicle, and the like. The steer-avoidance limit time-interval is a time interval starting from the final time point at which a collision with the obstacle is avoidable through steering by the driver and ending at a time point at which the collision is expected to occur if the steering is not conducted. Set as a steer-avoidance limit clock-time t2 is a time point preceding, by the steer-avoidance limit time-interval, the time point at which the collision is expected to occur if the steering is not conducted.

The deceleration correcting section 9 increases or decreases a time change rate a of the demanded deceleration G2 until the demanded deceleration G2 reaches the target deceleration G3, in accordance with the change in the degree of deviation (cf. FIG. 2 (c)). In FIG. 2 (c), a case is shown where the time change rate α is increased. Specifically, when the change in the degree of deviation is a negative value, the change ratio α is increased since a tendency of the detected deceleration G1 being smaller than the demanded deceleration G2 has become stronger as time progresses (cf. FIG. 2 (a)). That is, the change ratio α is corrected such that the demanded deceleration G2 increases quickly. Furthermore, when the change in the degree of deviation is a positive value, the change ratio α is decreased since a tendency of the detected deceleration G1 being larger than the demanded deceleration G2 has become stronger as time progresses. That is, the change ratio α is corrected such that the velocity at which the demanded deceleration G2 increase becomes smaller. In some cases, the change ratio α is corrected such that the demanded deceleration G2 decreases gradually.

Furthermore, the deceleration correcting section 9 increases or decreases the target deceleration G3 in accordance with the change in the degree of deviation (cf. FIG. 2 (c)). An increase or decrease of the target deceleration G3 is associated with an increase or decrease of the change ratio α of the demanded deceleration G2. Specifically, when the change in the degree of deviation is a negative value, the target deceleration G3 is increased since a tendency of the detected deceleration G1 being smaller than the demanded deceleration G2 has become stronger as time progresses (cf. FIG. 2 (c)). That is, the target deceleration G3 is corrected such that the demanded deceleration G2 increases quickly. Furthermore, when the change in the degree of deviation is a positive value, the target deceleration G3 is decreased since a tendency of the detected deceleration G1 being larger than the demanded deceleration G2 has become stronger as time progresses. That is, the target deceleration G3 is corrected such that the velocity at which the demanded deceleration G2 increases becomes smaller. In some cases, the target deceleration G3 is corrected such that the demanded deceleration G2 decreases gradually.

Next, an operation of the brake control device 1 will be described using a flowchart in FIG. 3.

First, it is determined whether the collision risk is equal to or higher than a predetermined value (step S1). At step S1, when the collision risk is determined to be lower than the predetermined value, the process ends. On the other hand, when the collision risk is determined to be equal to or higher than the predetermined value, the process advances to step S2.

At step S2, the target deceleration G3 necessary for collision avoidance is calculated. Next, at step S3, an automatic-braking function of the automatic brake device 8 is turned on.

Next, at step S4, a time interval, from a clock time t0 when the automatic-braking function is turned on, to the steer-avoidance limit clock-time t2, is calculated. Next, at step S5, it is determined whether a time from the clock time t0 is equal to or longer than the time interval of the delay of the response by the automatic brake device 8 (i.e., whether time has arrived at or has passed the start time t1 of the predetermined period T1). When it is determined that time has not arrived at the start time t1, the process ends. On the other hand, when it is determined that time has arrived at or has passed the start time t1, the process advances to step S6.

At step S6, the degree of deviation of the true deceleration G1 with regard to the demanded deceleration G2 is calculated. Next, at step S7, it is determined whether time has arrived at or has passed the clock time t2. When it is determined that time has not arrived at the clock time t2, the process returns to step S5. On the other hand, when it is determined that time has arrived at or has passed the clock time t2, the process advances to step S8.

At step S8, the change of the degree of deviation in the predetermined period T1 is calculated. Next, at step S9, based on the change in the degree of deviation, a post-correction change ratio α and a post-correction target deceleration G3 are calculated. Next, at step S10, the change ratio α and the target deceleration G3 are corrected to the calculated post-correction change ratio α and post-correction target deceleration G3. With this, the process ends.

As describe above, according to the first embodiment, the braking force is appropriately controlled, by correcting the target deceleration G3 and the change ratio α of the demanded deceleration G2 based on the change in the degree of deviation between the detected deceleration G1 and the demanded deceleration G2 within the predetermined period T1 included in the rising braking force period T2. With this, it becomes possible to control the braking force part way through the rising braking force period T2. Therefore, the control of the braking force can be conducted from an early stage, allowing the automatic brake device 8 to exert an appropriate braking force regardless of the state of the brake pad and the like.

It should be noted that, in another embodiment, in addition to the configuration of the above described first embodiment, a storing section (not shown) configured to store the post-correction change ratio α and the post-correction target deceleration G3 may be provided. In such as case, a step (not shown) is inserted between step S9 and step S10 in the flowchart of FIG. 3 so as to store the post-correction change ratio α and the post-correction target deceleration G3 that have been calculated. With this step, the post-correction change ratio α and the post-correction target deceleration G3 are updated and stored in every single flow from step S1 to S10. As a result, in every flow, the braking control can be conducted more appropriately since correction is conducted based on the post-correction change ratio α and the post-correction target deceleration G3 that have been updated and stored.

It should be noted that, instead of controlling the deceleration, a brake fluid pressure can be directly controlled, by having a brake fluid pressure detector, a target brake fluid pressure calculating section, and a brake fluid pressure correcting section instead of the deceleration detector 2, the target deceleration calculating section 5, and the deceleration correcting section 9 of the first embodiment. Also in this case, the same advantageous effect of the first embodiment can be obtained.

### INDUSTRIAL APPLICABILITY

The present invention is applicable to a brake control device that corrects a braking force within a period of rising of the braking force so as to allow an automatic brake device to exert an appropriate braking force regardless of a state of a brake pad.

### DESCRIPTION OF THE REFERENCE CHARACTERS

1 brake control device

2 deceleration detector

3 controller

4 object detector

5 target deceleration calculating section

6 steer-avoidance limit time-interval calculating section

7 collision risk determining section

8 automatic brake device

9 deceleration correcting section

T1 predetermined period

T2 rising braking force period

G1 detected deceleration (true deceleration)

G2 demanded deceleration

G3 target deceleration

t0 time point when an operation instruction has been given to the automatic brake device

t1 start time of predetermined period

t2 end time of the predetermined period

1. A brake control device for supporting avoidance of a collision of one's own vehicle with an obstacle by using an automatic brake device, the brake control device comprising:
a deceleration detector configured to detect a deceleration of the own-vehicle;
a target deceleration calculating section configured to determine a risk of collision between the own-vehicle and the obstacle, and calculate a target deceleration based on the determined risk; and
a controller configured to set a demanded deceleration that gradually increases as time elapses in a braking force rising period so as to reach the target deceleration, and configured to control a braking force of the automatic brake device, based on a change, within a predetermined period, in a degree of deviation between the detected deceleration and the demanded deceleration at a time point when said deceleration has been detected, wherein
the predetermined period is included in the rising braking force period starting from a time point when an operation instruction is given to the automatic brake device and ending at a time point when the demanded deceleration reaches the target deceleration.

2. The brake control device according to claim 1, wherein a control of the braking force is initiated at an end time of predetermined period or at around the end time.

3. The brake control device according to claim 1, wherein, in accordance with a change in the degree of deviation, the controller increases or decreases a ratio of change of the demanded deceleration until the demanded deceleration reaches the target deceleration.

4. The brake control device according to claim 1, wherein the controller increases or decreases the target deceleration in accordance with a change in the degree of deviation.

5. The brake control device according to claim 1, wherein a start time of the predetermined period is a time point that is reached when a time interval of a delay of a response by the automatic brake device to the operation instruction has elapsed after a time point when the operation instruction has been given.

6. The brake control device according to claim 1, wherein an end time of the predetermined period is a final time point at which a collision with the obstacle is avoidable through steering by a driver.

7. The brake control device according to claim 1, wherein a change in the degree of deviation is a ratio of a difference between the demanded deceleration and the detected deceleration, with regard to the demanded deceleration.

8. The brake control device according to claim 1, wherein a change in the degree of deviation is obtained by integrating a difference between the target deceleration and the detected deceleration over time.

9. A brake control device for supporting avoidance of a collision of one's own vehicle with an obstacle by using an automatic brake device, the brake control device comprising:
a brake fluid pressure detector configured to detect a brake fluid pressure of the automatic brake device;
a target brake fluid pressure calculating section configured to determine a risk of collision between the own-vehicle and the obstacle, and calculate a target brake fluid pressure based on the determined risk; and
a controller configured to set a demanded brake fluid pressure that gradually increases as time elapses in a braking force rising period so as to reach the target brake fluid pressure, and configured to control a braking force of the automatic brake device, based on a change, within a predetermined period, in a degree of deviation between the detected brake fluid pressure and the demanded brake fluid pressure at a time point when said brake fluid pressure has been detected, wherein
the predetermined period is included in the rising braking force period starting from a time point when an operation instruction is given to the automatic brake device and ending at a time point when the demanded brake fluid pressure reaches the target brake fluid pressure.
